(19) United States
(12) Patent Application Publication
(10) Pub. No.: US 2007/0175082 A1
(43) Pub. Date: Aug. 2, 2007

(54) Radio controlled boat

(76) Inventor: Clive Vernon Barrett, Margate (ZA)

Correspondence Address: Susan Barrett, P O Box 726, Margate, 4275, ZA

(21) Appl. No.: 10/586,385

(22) PCT Filed: Feb. 2, 2005
(86) PCT No.: PCT/ZA05/00009

§ 371 Date: Jul. 17, 2006

(30) Foreign Application Priority Data
Feb. 18, 2004 (ZA) 2004/1293
Feb. 2, 2005 (AU) 2005211822

(51) Int. Cl. A01K 89/00

(52) U.S. Cl. 43/26.1

(57) ABSTRACT

This invention is a surf-launched, a submersible, self-righting radio controlled boat. It is one meter in length, 30 cm wide with a draught of 25 cm. The boat is electrically powered and operates on two 8 amp/hour dry cell batteries which power a 200 watt motor to which a 3:1 ratio reduction gearbox is attached driving a 115 mm 3-blade propeller. It is ideal for delivering a baited fishing line up to one km in oceans, dams and rivers. It is ideally used in conjunction with a battery-operated motorized winch whereby a line from the winch is attached to the boat in addition to the fishing line. Once the fishing line has been released, the winch pulls the boat back to shore. Other applications include underwater photography, recreation or life-saving where the boat itself, fitted with handles becomes a motorized life-buoy or the boat can be used to tow a life-buoy to a drowning bather.

### BACKGROUND ART

A bait boat is a radio controlled vessel to which a fishing line and baited hook are attached and carried out to the middle of a lake, for example, where the distance is too great for the fishing hook to be placed by casting. Similarly salt-water anglers may wish to fish beyond the breakers, and again a bait boat would be a desirable means to achieve this.

Whilst bait boats for fresh-water fishing are known, these have not been successfully adapted for use in the sea. They tend to topple easily in the waves and are unable to right themselves. As a result they have been found to be ineffective in the sea.

One of the reasons for their inability to remain upright in swells is that prior art bait boats float atop the water and have super-structures, which are acted upon by the waves, resulting in overturning.

It is therefore an object of this invention to provide a bait boat which lies low in the water, has little or no superstructure, is submersible and which is further self-righting in the event that overturning occurs.

It is a further object of this invention to provide a vessel for delivering a detachable life-saving device for both fresh water and salt-water situations. Yet a further object of this invention is to provide a remote controlled life-saving vessel.

An alternative object of the invention is to provide a remote controlled vessel for housing photographic equipment for use in underwater photography.

A further object of the invention is to provide a recreational or promotional vessel.

### DESCRIPTION OF THIS INVENTION

According to the invention, a floatable vessel includes a weighted keel having a depth below the waterline substantially greater than the height of the dock above the waterline and a self-sighting mechanism comprising a lightweight float mount at one end of the flexible elongate element, the other end of the elongate element being attached to a biasing means secured to the deck of the vessel, wherein, in the event of the vessel capsizing, the force of the water on the keel and the force of the self-righting mechanism and the longitudinal axis of the vessel act together to right the vessel.

In the preferred form of this invention, the ratio of the depth of the keel to the height of the deck above the waterline is greater than or equal to 5:1. The weight of the keel is greater than normal due to the location of the motor and its components within the keel and comprises the major portion of the weight of the boat.

Also in the preferred form of the invention, the hull of the vessel includes a deep central keel formation located along the longitudinal axis of the vessel between twin hulls of substantially reduced depth relative to that of the keel.

In the preferred form of this invention the self-righting mechanism is anchored to a point along the longitudinal axis of the vessel.

Also in the preferred form the biasing means comprises a coiled stainless steel spring with the elongated element comprising a stainless steel cable and the float a polystyrene ball or air-inflated ball.

The length of the stainless steel cable or alternatively the height of the float above the deck may be variable, permitting adjustment according to water conditions. A pilot light may be attached to the boat, cable or float for nighttime use.

The float may be bi-coloured, being divided into different-coloured halves parallel to the longitudinal axis of the boat. This enables an observer to tell from a distance in which direction the vessel is traveling.

In the preferred form of the invention, the vessel is remote controlled and in particular radio controlled, including a motor controllable by means of a signal transmitted from a remote location and receivable by an antenna located aboard the vessel and in communication with the motor and steering mechanism.

In this preferred form of the invention the vessel finds application as a bait boat for use by fishermen to quickly and efficiently locate their bait and required distance from the shore. To this end the boat includes a bait tray located towards the rear (stem) of the vessel and further includes a remotely activated flap, which is pivotable to an open position upon receipt of the appropriate signal from the control to release bait into the water.

In use, the bait boat would typically be remotely steered through the water from the shore, towing with it the bait attached to a fisherman's line, as well as a retrieval line attached to the front of the boat. The retrieval line is preferably a lightweight nylon cordiline and is used to retrieve the boat form the water in the event of engine failure. The retrieval line is payed out form a winch located on shore and is attached to a bow-ring on the boat.

The line is attached to the bow-ring and looped through the bait tray whilst the boat is being steered out into the water. Upon opening of the bait tray flap to release the bait the retrieval line is also released from the bait tray and when the line is pulled by the winch it automatically turns the bow of the boat around to face the winch.

The winch is preferably battery operated and housed in a waterproof enclosure. The winch is equipped with a slip-clutch to break the torque of its 25:1 pulley drive ratio. The incorporation of a constant tension brake release mechanism prevents the line from tangling. Whilst the boat can be operated without the retrieval line and winch, this is not ideal as the operator will have no easy way of retrieving the boat from a deep water in the event of mechanical or electrical failure unless the retrieval line is attached to a second reel and rod in which case the boat can be brought safely back to shore.

A second important feature of the boat is it's ability to submerge or dive under or through approaching waves in the same way that a surfer would push his board an approaching wave to avoid being washed towards the shore.

According to this second aspect of this invention, the vessel includes a trim tab to enable the vessel to submerge. In the preferred form, the trim tab comprises the stern section of the vessel, which has been lengthened to act as a trim tab. In the preferred form the stem section comprises approximately ⅓ length of the boat. Also in the preferred form, the underside of the trim tab is concavely arcuate to accentuate its ability to dive.

In the preferred form of the invention the ability of the boat to dive is a function of the length of the trim tab. For a 1 m boat, weighing around 15 kg the stern length is preferably 333 mm. These factors combine to enable the boat to dive when the speed of the boat is reduced.

In a modification or improvement of this invention, a bow extension element is releasably securable to the bow of the vessel to limit or extend dive capability. In one form, this comprises a similar shape to that of the bow of the vessel and in its simplest form serves to lengthen the bow.

In the preferred form of the invention the motor of the boat is comprised as follows:

Two 7.8 amp/hr dry cell batteries wired in parallel are connected through an on-off switch to a 300 amp Mosfet speed controller. This speed controller which operates in the mark space ration basis is connected to a brush motor wound to provide 12000 rpm at 12 volts. Drive torque is achieved with the use of a 3:1 reduction box, which provides a propeller speed underload of approximately 2500-3000 rpm. This has been calculated using a 110 mm 3-blade rough pitch propeller.

In an alternative from of the invention in which the vessel may be used as a life-saving apparatus or as a recreational motorized boat, the vessel may be provided with one or more inflatable tubes located about the perimeter of the deck to improve buoyancy. These may be self-inflating. In addition one or more handles may be provided along the length of the deck and/or at the stem to enable persons to grab hold of the vessel and be towed by it.

A lifesaving apparatus, for example a torpedo buoy, may be fastened to the vessel either using the bait tray or the handle provided.

In certain situations it may be less dangerous and more expedient to deliver a buoy to a swimmer in trouble than for a life-saver to reach that person in time. The vessel of the invention is ideal for such a task and may even be employed to tow that person to shore.

For reasons of its use in rough surf and to prevent possible damage to the rudder and/or propeller a propeller and rudder guard is provided.

### EMBODIMENT OF INVENTION

The preferred embodiments of the invention are described below with reference to the accompanying drawings:

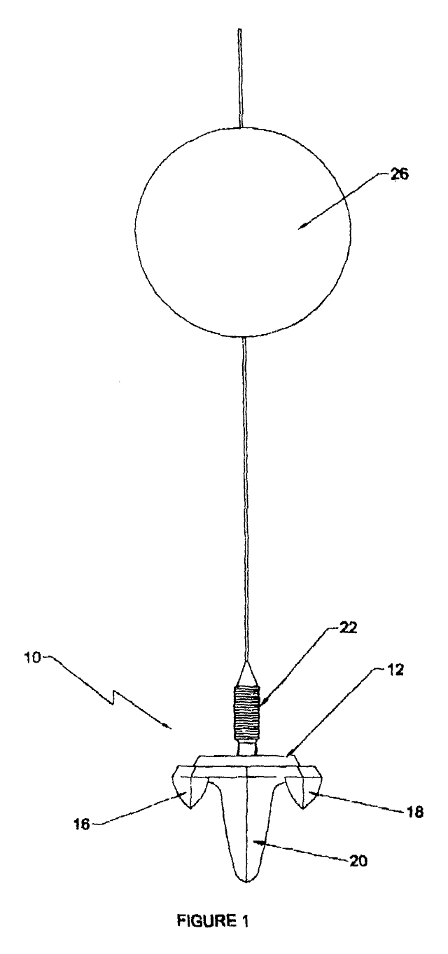

FIG. 1 is a front view of a boat according to the invention;

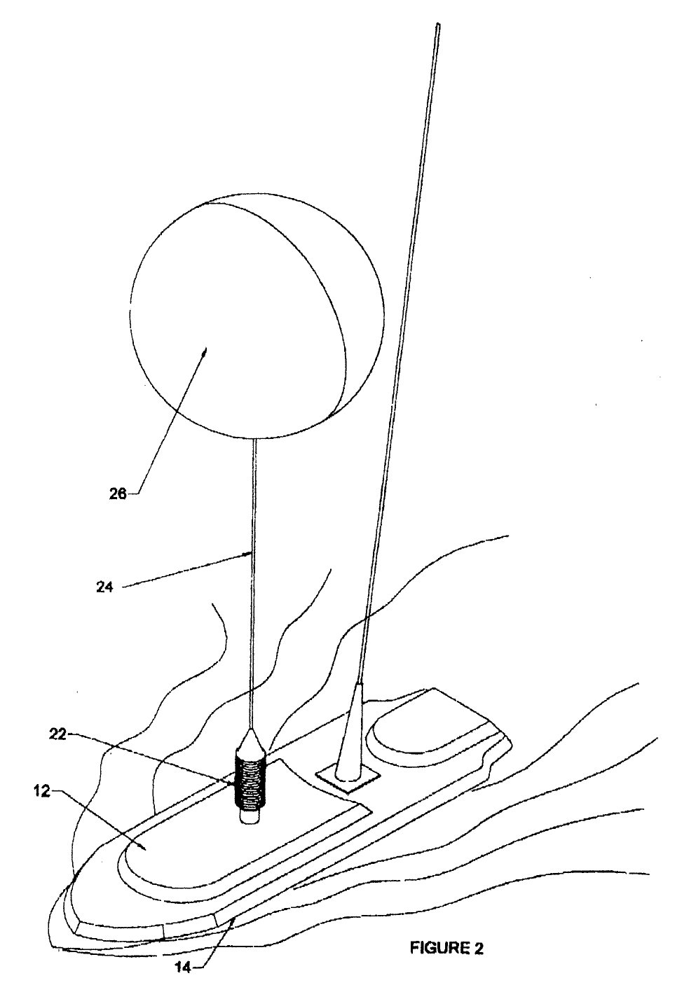

FIG. 2 is a view of the boat in the water;

FIG. 3 is a side view of the boat;

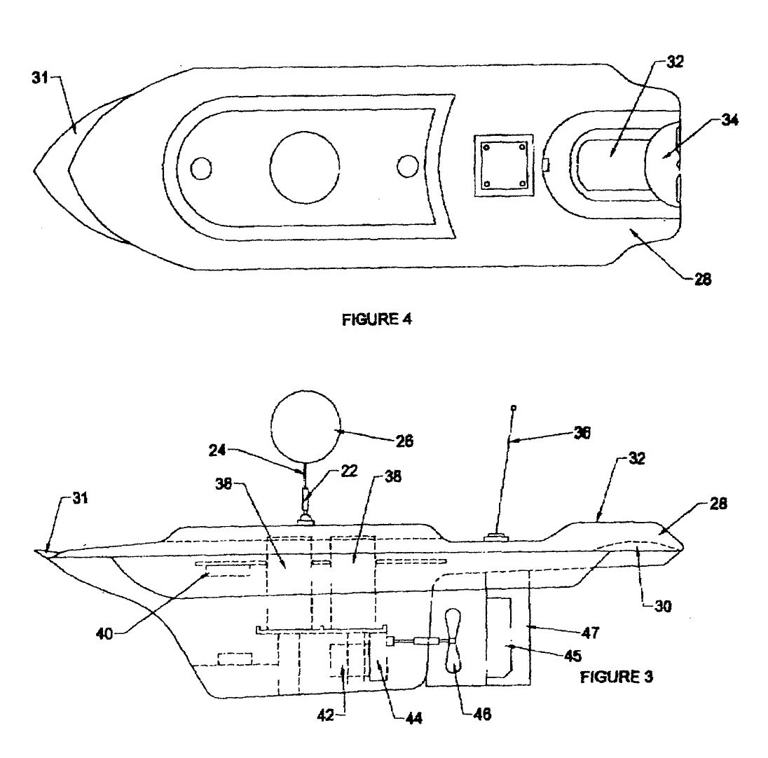

FIG. 4 is a top view of the boat;

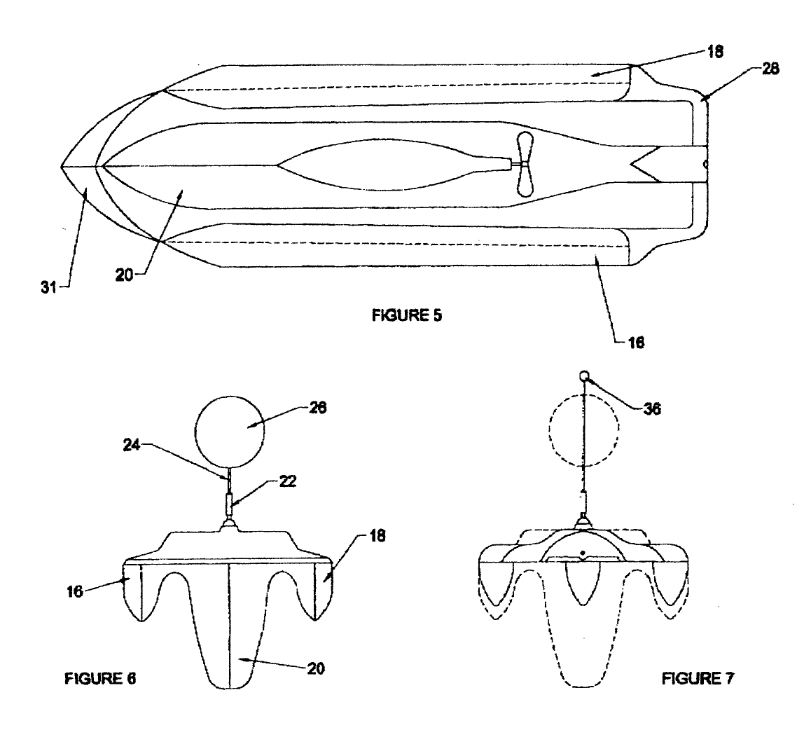

FIG. 5 is a bottom view of the boat;

FIG. 6 is a front (bow) view;

FIG. 7 is a rear (stern) view;

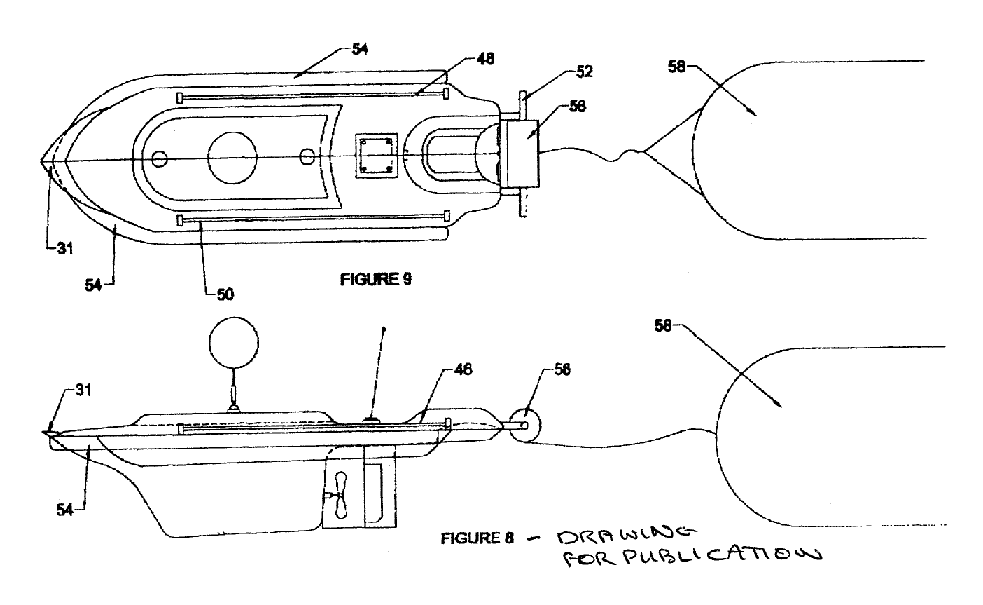

FIGS. 8 and 9 are side and top views of the boat adapted for use in life-saving.

In FIGS. 1 and 2 a radio controlled bait boat (10) of the invention has a substantially flat deck (12) which is only slightly raised above the water line (14). The boat has twin hulls (16, 18) and a deep and heavy central keel (20). The depth of the keel relative to the exposed height of the deck is approximately in the ratio 5:1 as shown in FIG. 3. This results in an extremely stable vessel.

The weight of the keel is substantial, with the components of the motor being housed therein as shown in FIG. 3.

Attached to the deck (12) is a self-righting mechanism comprising a coiled, stainless steel spring (22) mounted on the longitudinal axis of the deck, a flexible steel cable/whip (24) attached to the spring, with a polystyrene float (26) located at the other end of the whip. The self-righting mechanism operates by acting in conjunction with the weight of the keel to right the vessel when it is partially or fully capsized.

The float is bi-coloured to enable the observer to establish in which direction the boat is traveling.

The stern section (28) of the vessel is longer relative to the remainder of the boat and in essence, acts as an oversized trim tab to limit the boat to submerge at certain speeds. The underside of the stern is concave (30) to further adapt the stern to function as a trim tab.

When the speed of the boat is reduced to approximately one third of its maximum, the trim tab assists to submerge the bow of the boat and cause it to dive. This enables it to dive through oncoming waves. A removable bow extension (31) may be fitted to further assist diving.

In order to function as a bait boat, the deck includes a bait tray (32) covered by a hatch (34) which is hinged towards the stern of the boat. The hatch is remotely activable to open to release the bait into the water as shown in FIG. 2.

The Antenna (36) receives a transmission from a hand-held radio control (not shown) controlling operation of the motor and the bait tray hatch.

The motor and its components are housed within the keel as shown in FIG. 3. The motor is powered by two dry cell batteries (38) in parallel, which are connected through an on-off switch to a speed control device (40). The speed control operates a brush motor (42) with a 3:1 reduction box (44) Being used to provide the propeller (46) with the required torque. The pro-poller and rudder (45) are protected by a guard (47).

Turning now to FIGS. 8 and 9, the boat of the invention is shown to include additional features which will enhance its use as a lifesaving apparatus. Handles 48, 50) are provided along the length of the deck and at the stern of the boat (52) fro gripping by a rescued person. Inflatable stabilizer tubes (54) are fitted around the deci and at the stern (56) to provide additional buoyancy.

A torpedo buoy (58) or the like may be towed behind the boat and released for a drowning person. Alternatively, a drowning person may grip the handles (48, 50, 52) and be towed toward shore.

25. A floatable vessel according to claim 24 in which the bow extension comprises a similar shape to that of the bow of the vessel and serves to lengthen the bow.

26. A floatable vessel according to any of the above claims in which for a 110 mm 3-blade rough pitch propeller, the motor comprises two 7.8 to 9 amp/hr dry cell batteries wired in parallel, connected through an on-off switch to a 300 amp Mosfet speed controller operating in a mark space ration basis and being connected to a brush motor wound to provide 12000 rpm at 12 volts, drive torque being achieved with the use of a 3:1 reduction box which provides a propeller speed underload of approximately 2500-3000 rpm.

27. A floatable vessel according to any of the above claims in which the vessel is provided with one or more inflatable tubes located about the perimeter of the deck to improve buoyancy.

28. A floatable vessel according to claim 27 in which the tubes are self-inflating.

29. A floatable vessel according to claims 27 and 28 in which one or more handles are provided along the length of the deck and/or at the stern to enable persons to grab hold of the vessel and be towed by it.

30. A floatable vessel according to any of the above claims in which the vessel includes a propeller guard and/or rudder guard.

31. (canceled)
